(19) United States
(12) Patent Application Publication
(10) Pub. No.: US 2018/0216474 A1
(43) Pub. Date: Aug. 2, 2018

(54) Turbomachine Blade Cooling Cavity

(71) Applicant: General Electric Company, Chenectady, NY (US)

(72) Inventor: Mark Andrew Jones, Ponte Vedra Beach, FL (US)

(21) Appl. No.: 15/421,519

(22) Filed: Feb. 1, 2017

(51) Int. Cl. F01D 5/18; F01D 5/14

(52) U.S. Cl. CPC F01D 5/187; F01D 5/141; F05D 2260/2212; F05D 2240/307; F05D 2260/232; F05D 2220/32

(57) ABSTRACT

The present disclosure is directed to a blade for a turbomachine. The blade includes an airfoil having a pressure side surface and a suction side surface extending from a leading edge to a trailing edge. The airfoil defines a camber line positioned between the pressure side surface and the suction side surface and extending from the leading edge to the trailing edge. A tip shroud couples to the airfoil and defines a cooling cavity therein. The cooling cavity includes one or more turbulators positioned in one or two regions of a forward region, a central region, and an aft region.

### FIELD

The present disclosure generally relates to turbomachines. More particularly, the present disclosure relates to blade cooling cavities for turbomachines.

### BACKGROUND

A gas turbine engine generally includes a compressor section, a combustion section, a turbine section, and an exhaust section. The compressor section progressively increases the pressure of air entering the gas turbine engine and supplies this compressed air to the combustion section. The compressed air and a fuel (e.g., natural gas) mix within the combustion section and burn in a combustion chamber to generate high pressure and high temperature combustion gases. The combustion gases flow from the combustion section into the turbine section where they expand to produce work. For example, expansion of the combustion gases in the turbine section may rotate a rotor shaft connected to a generator to produce electricity. The combustion gases then exit the gas turbine engine through the exhaust section.

The turbine section generally includes a plurality of blades coupled to a rotor. Each blade includes an airfoil positioned within the flow of the combustion gases. In this respect, the blades extract kinetic energy and/or thermal energy from the combustion gases flowing through the turbine section. Certain blades may include a tip shroud coupled to the radially outer end of the airfoil. The tip shroud reduces the amount of combustion gases leaking past the blade.

The blades generally operate in extremely high temperature environments. As such, the rotor blades may define various passages, cavities, and apertures through which cooling air may flow. In particular, the tip shrouds may define various cavities therein through which the cooling air flows. In certain instances, it may be necessary to position turbulators in the tip shroud cavities. The turbulators create turbulence in the cooling air flowing through the cavities, which increases the rate of convective heat transfer from the tip shroud by the cooling air. However, the turbulence created by the turbulators reduces the pressure and flow rate of the cooling air flowing through the cavities, which may negatively impact the convective cooling.

### BRIEF DESCRIPTION

Aspects and advantages of the technology will be set forth in part in the following description, or may be obvious from the description, or may be learned through practice of the technology.

In one aspect, the present disclosure is directed to a blade for a turbomachine. The blade includes an airfoil having a pressure side surface and a suction side surface extending from a leading edge to a trailing edge. The airfoil defines a camber line positioned between the pressure side surface and the suction side surface and extending from the leading edge to the trailing edge. A tip shroud couples to the airfoil and defines a cooling cavity therein. The cooling cavity includes one or more turbulators positioned within one or two regions of a forward region, a central region, and an aft region.

In another aspect, the present disclosure is directed to a gas turbine engine including a compressor section, a combustion section, and a turbine section having one or more blades. Each blade includes an airfoil having a pressure side surface and a suction side surface extending from a leading edge to a trailing edge. The airfoil defines a camber line positioned between the pressure side surface and the suction side surface and extending from the leading edge to the trailing edge. A tip shroud couples to the airfoil and defines a cooling cavity therein. The cooling cavity comprises one or more turbulators positioned within at least one but not more than five portions of a pressure side portion of a forward region, a suction side portion of the forward region, a pressure side portion of a central region, a suction side portion of the central region, a pressure side portion of an aft region, and a suction side portion of the aft region.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 is a schematic view of an exemplary gas turbine engine in accordance with the embodiments disclosed herein;

FIG. 2 is a front view of an exemplary blade in accordance with the embodiments disclosed herein;

FIG. 3 is a cross-sectional view of an exemplary airfoil in accordance with the embodiments disclosed herein;

FIG. 4 is an alternate cross-sectional view of the airfoil shown in FIG. 3, illustrating a camber line in accordance with the embodiments disclosed herein;

FIG. 5 is a top view of a tip shroud in accordance with the embodiments disclosed herein;

FIG. 6 is a cross-sectional view of the rotor blade taken generally at line 6-6 in FIG. 2, illustrating various regions of a cooling cavity in the tip shroud in accordance with the embodiments disclosed herein;

FIG. 7 is a cross-sectional view of a portion of the tip shroud, illustrating a plurality of turbulators positioned therein in accordance with the embodiments disclosed herein;

FIG. 8 is a perspective view of one of the turbulators in accordance with the embodiments disclosed herein; and

FIG. 9 is a cross-sectional view of one of the turbulators in accordance with the embodiments disclosed herein.

Repeat use of reference characters in the present specification and drawings is intended to represent the same or analogous features or elements of the present technology.

### DETAILED DESCRIPTION

Reference will now be made in detail to present embodiments of the technology, one or more examples of which are illustrated in the accompanying drawings. The detailed description uses numerical and letter designations to refer to features in the drawings. Like or similar designations in the drawings and description have been used to refer to like or similar parts of the technology. As used herein, the terms “first”, “second”, and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows.

Each example is provided by way of explanation of the technology, not limitation of the technology. In fact, it will be apparent to those skilled in the art that modifications and variations can be made in the present technology without departing from the scope or spirit thereof. For instance, features illustrated or described as part of one embodiment may be used on another embodiment to yield a still further embodiment. Thus, it is intended that the present technology covers such modifications and variations as come within the scope of the appended claims and their equivalents.

Although an industrial or land-based gas turbine is shown and described herein, the present technology as shown and described herein is not limited to a land-based and/or industrial gas turbine unless otherwise specified in the claims. For example, the technology as described herein may be used in any type of turbomachine including, but not limited to, aviation gas turbines (e.g., turbofans, etc.), steam turbines, and marine gas turbines.

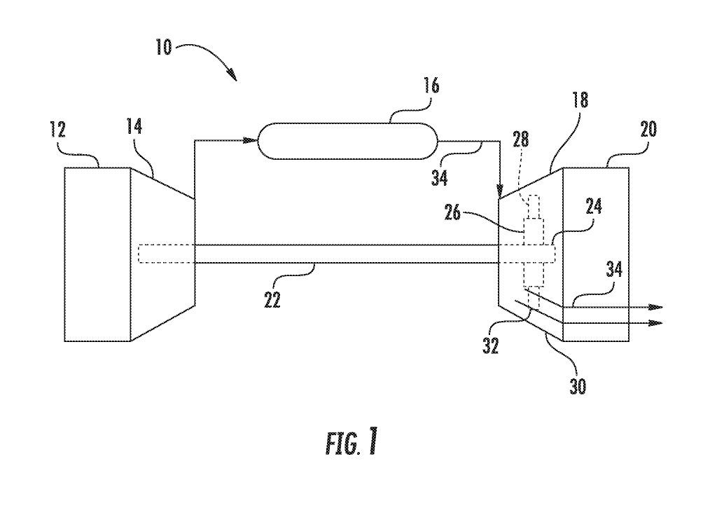

Referring now to the drawings, wherein identical numerals indicate the same elements throughout the figures, FIG. 1 schematically illustrates a gas turbine engine 10. It should be understood that the gas turbine engine 10 of the present disclosure need not be a gas turbine engine, but rather may be any suitable turbomachine, such as a steam turbine engine or other suitable engine. The gas turbine engine 10 may include an inlet section 12, a compressor section 14, a combustion section 16, a turbine section 18, and an exhaust section 20. The compressor section 14 and turbine section 18 may be coupled by a shaft 22. The shaft 22 may be a single shaft or a plurality of shaft segments coupled together to form the shaft 22.

The turbine section 18 may generally include a rotor shaft 24 having a plurality of rotor disks 26 (one of which is shown) and a plurality of rotor blades 28 extending radially outward from and being interconnected to the rotor disk 26. Each rotor disk 26, in turn, may be coupled to a portion of the rotor shaft 24 that extends through the turbine section 18. The turbine section 18 further includes an outer casing 30 that circumferentially surrounds the rotor shaft 24 and the rotor blades 28, thereby at least partially defining a hot gas path 32 through the turbine section 18.

During operation, air or another working fluid flows through the inlet section 12 and into the compressor section 14, where the air is progressively compressed to provide pressurized air to the combustors (not shown) in the combustion section 16. The pressurized air mixes with fuel and burns within each combustor to produce combustion gases 34. The combustion gases 34 flow along the hot gas path 32 from the combustion section 16 into the turbine section 18. In the turbine section, the rotor blades 28 extract kinetic and/or thermal energy from the combustion gases 34, thereby causing the rotor shaft 24 to rotate. The mechanical rotational energy of the rotor shaft 24 may then be used to power the compressor section 14 and/or to generate electricity. The combustion gases 34 exiting the turbine section 18 may then be exhausted from the gas turbine engine 10 via the exhaust section 20.

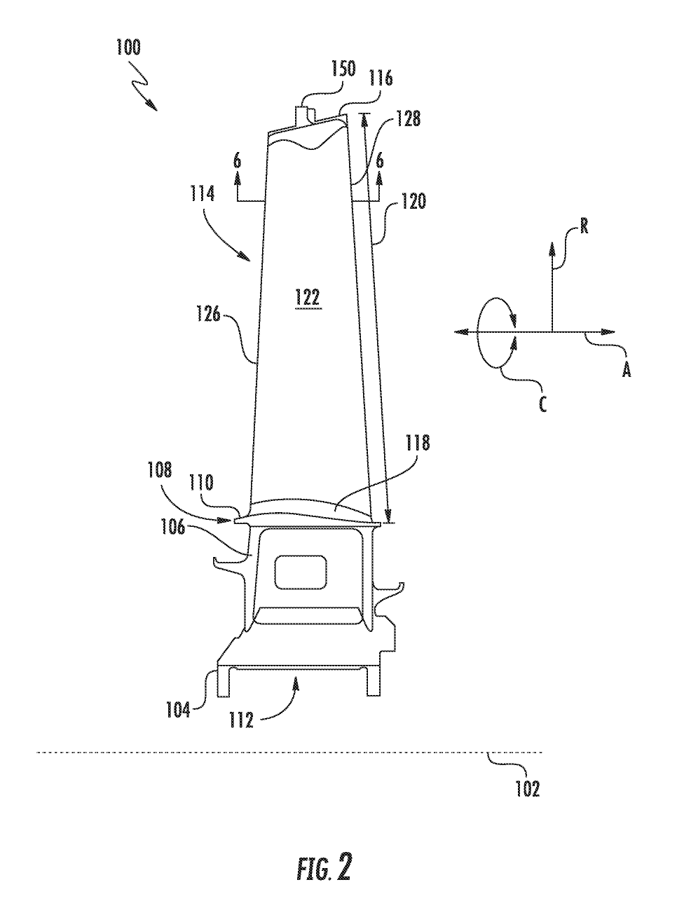

FIG. 2 is a view of an exemplary rotor blade 100, which may be incorporated into the turbine section 18 of the gas turbine engine 10 in place of the rotor blade 28. As shown, the rotor blade 100 defines an axial direction A, a radial direction R, and a circumferential direction C. In general, the axial direction A extends parallel to an axial centerline 102 of the shaft 24 (FIG. 1), the radial direction R extends generally orthogonal to the axial centerline 102, and the circumferential direction C extends generally concentrically around the axial centerline 102. The rotor blade 100 may also be incorporated into the compressor section 14 of the gas turbine engine 10 (FIG. 1).

As illustrated in FIG. 2, the rotor blade 100 may include a dovetail 104, a shank portion 106, and a platform 108. More specifically, the dovetail 104 secures the rotor blade 100 to the rotor disk 26 (FIG. 1). The shank portion 106 couples to and extends radially outward from the dovetail 104. The platform 108 couples to and extends radially outward from the shank portion 106. The platform 108 includes a radially outer surface 110, which generally serves as a radially inward flow boundary for the combustion gases 34 flowing through the hot gas path 32 of the turbine section 18 (FIG. 1). The dovetail 104, shank portion 106, and platform 108 may define an intake port 112, which permits cooling air (e.g., bleed air from the compressor section 14) to enter the rotor blade 100. In the embodiment shown in FIG. 2, the dovetail 104 is an axial entry fir tree-type dovetail. Alternately, the dovetail 104 may be any suitable type of dovetail. In fact, the dovetail 104, shank portion 106, and/or platform 108 may have any suitable configurations.

Referring now to FIGS. 2 and 3, the rotor blade 100 further includes an airfoil 114. In particular, the airfoil 114 extends radially outward from the radially outer surface 110 of the platform 108 to a tip shroud 116. The airfoil 114 couples to the platform 108 at a root 118 (i.e., the intersection between the airfoil 114 and the platform 116). In this respect, the airfoil 118 defines an airfoil span 120 extending between the root 118 and the tip shroud 116. The airfoil 114 also includes a pressure side surface 122 and an opposing suction side surface 124 (FIG. 3). The pressure side surface 122 and the suction side surface 124 are joined together or interconnected at a leading edge 126 of the airfoil 114, which is oriented into the flow of combustion gases 34 (FIG. 1). The pressure side surface 122 and the suction side surface 124 are also joined together or interconnected at a trailing edge 128 of the airfoil 114 spaced downstream from the leading edge 126. The pressure side surface 122 and the suction side surface 124 are continuous about the leading edge 126 and the trailing edge 128. The pressure side surface 122 is generally concave, and the suction side surface 124 is generally convex.

As shown in FIG. 3, the airfoil 114 may define one or more cooling passages 130 extending therethrough. More specifically, the cooling passages 130 may extend from the tip shroud 116 radially inward to the intake port 112. In this respect, cooling air may flow through the cooling passages 130 from the intake port 112 to the tip shroud 116. In the embodiment shown in FIG. 3, for example, the airfoil 114 defines seven cooling passages 130. In alternate embodiments, however, the airfoil 114 may define more or fewer cooling passages 130 and the cooling passages 130 may have any suitable configuration.

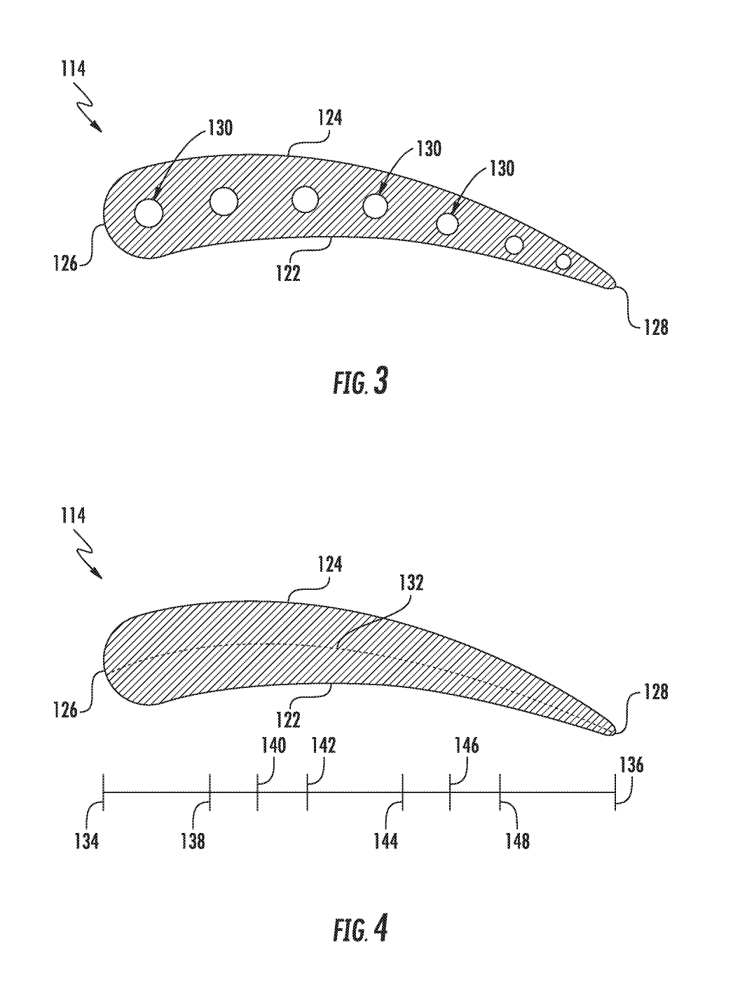

Referring now to FIG. 4, the airfoil 114 defines a camber line 132. As shown, the camber line 132 extends from the leading edge 126 to the trailing edge 128. The camber line 132 also is positioned between and equidistant form the pressure side surface 122 and the suction side surface 124. The leading edge 126 is positioned at zero percent of the camber line 132, and the trailing edge 128 is positioned at one hundred percent of the camber line 132. As shown in FIG. 4, zero percent of the camber line 132 is identified by 134, and one hundred percent of the camber line 132 is identified by 136. Furthermore, twenty percent of the camber line 132 is identified by 138, thirty percent of the camber line 132 is identified by 140, forty percent of the camber line 132 is identified by 142, sixty percent of the camber line 132 is identified by 144, seventy percent of the camber line 132 is identified by 146, and eighty percent of the camber line 132 is identified by 148. Other positions along the camber line 132 may be defined as well.

As indicated above, the rotor blade 100 includes the tip shroud 116 coupled to the radially outer end of the airfoil 114. In this respect, the tip shroud 116 may generally define the radially outermost portion of the rotor blade 100. The tip shroud 116 reduces the amount of the combustion gases 34 (FIG. 1) that escape past the rotor blade 100. As shown in FIG. 2, the tip shroud 116 may include a seal rail 150 extending radially outwardly therefrom. Alternate embodiments, however, may include more seal rails 150 (e.g., two seal rails 150, three seal rails 150, etc.) or no seal rails 150 at all.

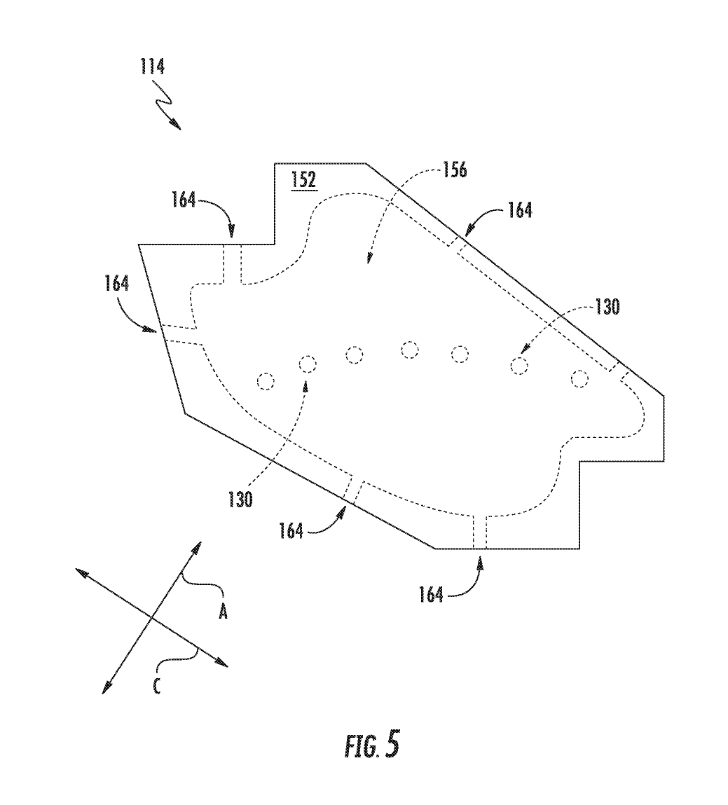

FIGS. 5 and 6 illustrate the tip shroud 116 in greater detail. In particular, FIG. 5 is a top view of the tip shroud 116. As shown, the tip shroud 116 includes a radially outer surface 152. The seal rail 150 shown in FIG. 2, which extends radially outward from the radially outer surface 152, is omitted from FIG. 5 for clarity. FIG. 6 is a cross-sectional view of the rotor blade 100, illustrating the underside of the tip shroud 116. As illustrated, the tip shroud 116 includes a radially inner surface 154, which is exposed to the combustion gases 34 flowing through the hot gas path 32 of the turbine section 18 (FIG. 1). The cooling passages 130 shown in FIG. 3, which extend through the airfoil 114, are omitted from FIG. 6 for clarity.

The tip shroud 116 defines various passages, cavities, and apertures to facilitate cooling thereof. More specifically, the tip shroud 116 defines a cooling cavity 156 in fluid communication with one or more of the cooling passages 130. The cooling cavity 156 may be a single continuous cavity as shown in FIG. 5. Alternately, the cooling cavity 156 may include different chambers fluidly coupled by various passages or apertures. The tip shroud 116 defines one or more outlet apertures 164 that fluidly couple the cooling cavity 156 to the hot gas path 32 (FIG. 1). Moreover, the tip shroud 116 may define any suitable configuration of passages, cavities, and/or apertures.

During operation of the gas turbine engine 10, cooling air flows through the passages, cavities, and apertures described above to cool the tip shroud 116. More specifically, cooing air (e.g., bleed air from the compressor section 14) enters the rotor blade 100 through the intake port 112 (FIG. 2). At least a portion of this cooling flows through the cooling passages 130 and into the cooling cavity 156 in the tip shroud 116. While flowing through the cooling cavity 156, the cooling air convectively cools the various walls of the tip shroud 116. The cooling air may then exit the cooling cavity 156 through the outlet apertures 164 and flow into the hot gas path 32 (FIG. 1).

In order to provide sufficient cooling to the tip shroud 116 while maintaining a relatively high cooling air pressure and flow rate therein, turbulators are selectively positioned within certain regions of the cooling cavity 156. More specifically, the rate of convective heat transfer may be insufficient to cool particular portions of the tip shroud 116 without the assistance of turbulators. Conversely, placing turbulators throughout the cooling cavity 156 creates an undesirable drop in the pressure and flow rate of the cooling air therein. In this respect, the turbulators are selectively positioned in the regions of the cooling cavity 156 where enhanced convection is necessary to achieve the desired high heat transfer rates. The remaining regions of the cooling cavity 156 are free from turbulators such that the flow of cooling air remains unobstructed in these regions. By targeting enhanced convection via turbulation in to only certain regions of the cooling cavity 156 (i.e., localizing the turbulation), the cooling air flowing through the tip shroud 116 retains the desired pressure and flow rate.

Referring particularly to FIG. 6, the cooling cavity 156 may be divided into various regions in which the turbulators may be selectively placed to provide localized turbulence. In particular, the cooling cavity 156 includes a forward region 158, a central region 160, and an aft region 162. The forward region 158 and the central region 160 are separated by a line 166, and the central region 160 and the aft region 162 are separated by a line 168. The lines 166, 168 extend orthogonally outward from the camber line 132.

The forward, central, and aft regions 158, 160, 162 may occupy various portions of the cooling cavity 156. In the embodiment shown in FIG. 6, the forward region 158 is positioned forward of thirty percent 140 of the camber line 132, the central region 160 is positioned between thirty percent 140 and seventy percent 146 of the camber line 132, and the aft region 162 is positioned aft of seventy percent 146 of the camber line 132. In alternate embodiments, the forward region 158 may be positioned forward of twenty percent 138 of the camber line 132, the central region 160 may be positioned between twenty percent 138 and eighty percent 148 of the camber line 132, and the aft region 162 may be positioned aft of eighty percent 148 of the camber line 132. In further embodiments, the forward region 158 may be positioned forward of forty percent 142 of the camber line 132, the central region 160 may be positioned between forty percent 142 and sixty percent 144 of the camber line 132, and the aft region 162 may be positioned aft of sixty percent 144 of the camber line 132. Although, the forward, central, and aft regions 158, 160, 162 may occupy any suitable portions of the cooling cavity 156.

The forward, central, and aft regions 158, 160, 162 of the cooling cavity 156 may be divided into pressure side and suction side portions. More specifically, the forward region 158 may include a pressure side portion 170 positioned on a pressure side 172 of the camber line 132 and a suction side portion 174 positioned on a suction side 176 of the camber line 132. The central region 160 may include a pressure side portion 177 positioned on the pressure side 172 of the camber line 132 and a suction side portion 178 positioned on the suction side 176 of the camber line 132. The aft region 162 may include a pressure side portion 179 positioned on the pressure side 172 of the camber line 132 and a suction side portion 180 positioned on the suction side 176 of the camber line 132.

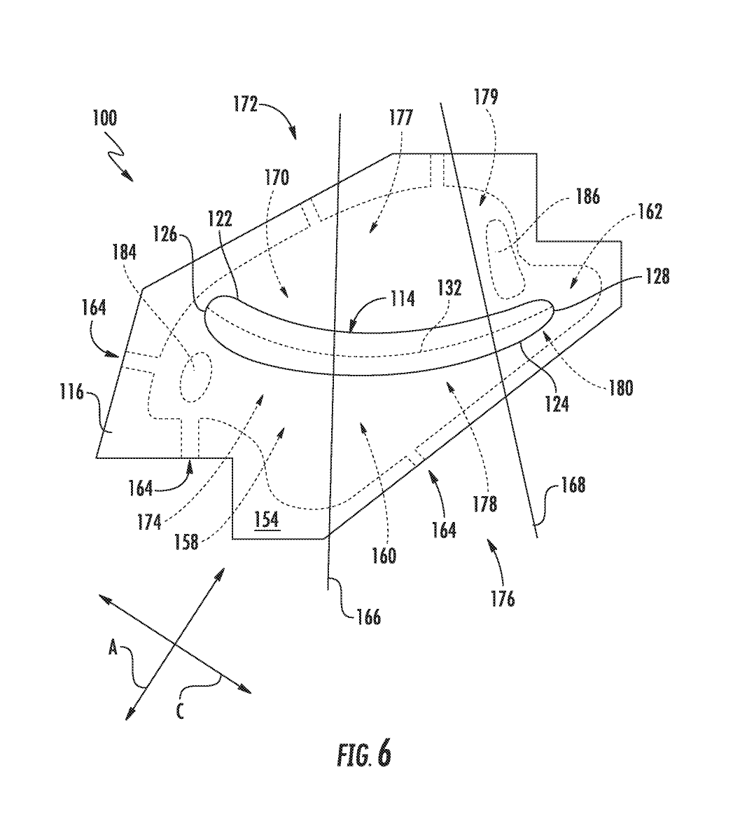

As mentioned above, the turbulators are selectively positioned within various regions or portions of regions of the cooling cavity 156. In particular, one or more turbulators 182 (FIG. 7) may be positioned within one or two regions of the forward, central, and aft regions 158, 160, 162. In this respect, at least one of the forward, central, and aft regions 158, 160, 162 may be free from the turbulators 182. In the embodiment shown in FIG. 6, for example, a first set of turbulators 184 is positioned within the forward region 158 and a second set of turbulators 186 is positioned with the aft region 162. As such, the central region 160 may be free from turbulators. In alternate embodiments, however, the any combination of the forward, central, and aft regions 158, 160, 162 may include the turbulators 182 so long as at least one of the regions 158, 160, 162 includes the turbulators 182 and at least one of the regions 158, 160, 162 is devoid of turbulators.

As mentioned above, the forward, central, and aft regions 158, 160, 162 may be divided into pressure side portions and suction side portions. In this respect, the one or more turbulators 182 may be positioned within at least one but not more than five portions of the pressure side portion 170 and suction side portion 174 of the forward region 158, the pressure side portion 177 and suction side portion 178 of the central region 160, and the pressure side portion 179 and suction side portion 180 of the aft region 162. In this respect, at least one of the portions 170, 174, 177, 178, 179, 180 is free from the turbulators 182. In the embodiment shown in FIG. 6, for example, the first set of turbulators 184 is positioned within the suction side portion 174 of the forward region 158 and the second set of turbulators 186 is positioned within the pressure side portion 179 of the aft region 162. As such, the pressure side portion 170 of the forward region 158, the pressure side portion 177 and suction side portion 178 of the central region 160, and the suction side portion 180 of the aft region 162 are free from turbulators. In alternate embodiments, however, the any combination of the portions 170, 174, 177, 178, 179, 180 may include the turbulators 182 so long as at least one of the portions 170, 174, 177, 178, 179, 180 includes the turbulators 182 and at least one of the portions 170, 174, 177, 178, 179, 180 is devoid of turbulators.

FIG. 7 illustrates an embodiment of the first or second set of turbulators 184, 186. As shown, the set of turbulators 184, 186 includes six turbulators 182. Nevertheless, the set of turbulators 184, 186 may include any suitable number of turbulators 182. Furthermore, the turbulators 182 extend radially outward from a radially inner surface 188 defining the cooling cavity 156 in the embodiment shown in FIG. 7. In alternate embodiments, however, the turbulators 182 may extend radially inward from a radially outer surface 190 defining the cooling cavity 156. Although, the turbulators 182 may extend outward from any surface defining the cooling cavity 156.

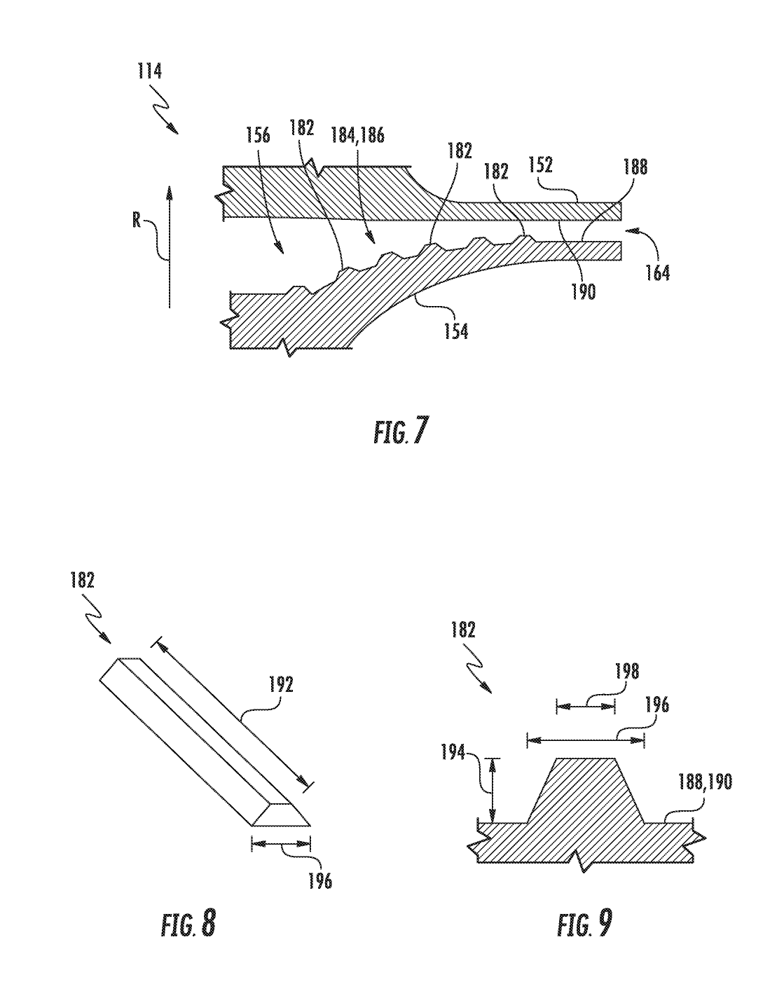

FIGS. 8 and 9 illustrate an embodiment of one of the turbulators 182. As shown, the turbulator 182 is a fin, such as a fin that narrows as it extends away from the surface 188, 190. In this respect, the turbulator 182 includes a length 192, a height 194, a base width 196, and a tip width 198. Since the turbulator 182 may narrow as it extends outwardly, the base width 196 may be longer than the tip width 198. Furthermore, the length 192 may be longer, such as five times longer, ten times longer, etc., than the height 194, the base width 196, and/or the tip width 198. In alternate embodiments, however, the turbulator 182 may be a dimple or a projection having any suitable geometric shape (e.g., cylindrical, hemispherical, etc.) and/or proportions.

As discussed in greater detail above, the turbulators 182 are selectively positioned in certain regions or portions of the cooling cavity 156, such as the forward and aft regions 158, 162. Furthermore, other regions of the cooling cavity 156 are free from turbulators 182. In this respect, and unlike in conventional cooling cavity configurations, the turbulators 182 create localized turbulation in the cooling air only in the specific regions of the cooling cavity 156. The cooling air remains unobstructed in the other regions of the cooling cavity 156. As such, and unlike conventional cooling cavities, the cooling cavity 156 provides a heat transfer rate sufficient to cool the tip shroud while maintaining a desirable cooling air pressure and flow rate therethrough.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A blade for a turbomachine, comprising:
an airfoil including a pressure side surface and a suction side surface extending from a leading edge to a trailing edge, the airfoil defining a camber line positioned between the pressure side surface and the suction side surface and extending from the leading edge to the trailing edge; and
a tip shroud coupled to the airfoil, the tip shroud defining a cooling cavity therein, wherein the cooling cavity comprises one or more turbulators positioned within one or two regions of a forward region, a central region, and an aft region.

2. The blade of claim 1, wherein the forward region is positioned forward of forty percent of the camber line, the central region is positioned between forty percent and sixty percent of the camber line, and the aft region is positioned aft of sixty percent of the camber line.

3. The blade of claim 1, wherein the forward region is positioned forward of thirty percent of the camber line, the central region is positioned between thirty percent and seventy percent of the camber line, and the aft region is positioned aft of seventy percent of the camber line.

4. The blade of claim 1, wherein the forward region is positioned forward of twenty percent of the camber line, the central region is positioned between twenty percent and eighty percent of the camber line, and the aft region is positioned aft of eighty percent of the camber line.

5. The blade of claim 1, wherein the two regions comprise the forward region and the aft region.

6. The blade of claim 1, wherein the forward region comprises a pressure side portion positioned on a pressure side of the camber line and a suction side portion positioned on a suction side of the camber line, the central region comprises a pressure side portion positioned on the pressure side of the camber line and a suction side portion positioned on the suction side of the camber line, and the aft region comprises a pressure side portion positioned on the pressure side of the camber line and a suction side portion positioned on the suction side of the camber line.

7. The blade of claim 6, wherein a first set of turbulators is positioned within the suction side portion of the forward region and a second set of turbulators is positioned within the pressure side portion of the aft region.

8. The blade of claim 1, wherein the one or more turbulators comprises a plurality of fins.

9. The blade of claim 1, wherein the one or more turbulators have an outwardly narrowing cross section.

10. The blade of claim 1, wherein the one or more turbulators comprise a length, a width, and a height, and wherein the length is at least five times greater than the width or the height.

11. A blade for a turbomachine, comprising:
an airfoil including a pressure side surface and a suction side surface extending from a leading edge to a trailing edge, the airfoil defining a camber line positioned between the pressure side surface and the suction side surface and extending from the leading edge to the trailing edge; and
a tip shroud coupled to the airfoil, the tip shroud defining a cooling cavity therein, wherein the cooling cavity comprises one or more turbulators positioned within at least one but not more than five portions of a pressure side portion of a forward region, a suction side portion of the forward region, a pressure side portion of a central region, a suction side portion of the central region, a pressure side portion of an aft region, and a suction side portion of the aft region.

12. The blade of claim 11, wherein the forward region is positioned forward of forty percent of the camber line, the central region is positioned between forty percent and sixty percent of the camber line, and the aft region is positioned aft of sixty percent of the camber line.

13. The blade of claim 11, wherein the forward region is positioned forward of thirty percent of the camber line, the central region is positioned between thirty percent and seventy percent of the camber line, and the aft region is positioned aft of seventy percent of the camber line.

14. The blade of claim 11, wherein the forward region is positioned forward of twenty percent of the camber line, the central region is positioned between twenty percent and eighty percent of the camber line, and the aft region is positioned aft of eighty percent of the camber line.

15. The blade of claim 11, wherein the pressure side portion of the forward region is positioned on a pressure side of the camber line, the suction side portion of the forward region is positioned on a suction side of the camber line, the pressure side portion of the central region is positioned on the pressure side of the camber line, the suction side portion of the central region is positioned on the suction side of the camber line, the pressure side portion of the aft region is positioned on the pressure side of the camber line, and the suction side portion of the aft region is positioned on a suction side of the camber line.

16. The blade of claim 11, wherein the between one and five regions comprises the suction side portion of the forward region or the pressure side portion of the aft region.

17. The blade of claim 11, wherein a first set of turbulators is positioned within the suction side portion of the forward region and a second set of turbulators is positioned within the pressure side portion of the aft region.

18. The blade of claim 11, wherein the one or more turbulators comprises a plurality of fins.

19. The blade of claim 11, wherein the one or more turbulators have an outwardly narrowing cross section.

20. The blade of claim 11, wherein the one or more turbulators comprise a length, a width, and a height, and wherein the length is at least five times greater than the width or the height.
